(19) United States
(12) Patent Application Publication
(10) Pub. No.: US 2007/0080234 A1
(43) Pub. Date: Apr. 12, 2007

(54) Transparent icon and use on consumer product packaging

(75) Inventor: Brett Christopher Domoy, Brookfield, CT (US)

Correspondence Address: UNILEVER INTELLECTUAL PROPERTY GROUP, 700 SYLVAN AVENUE,, BLDG C2 SOUTH, ENGLEWOOD CLIFFS, NJ, 07632-3100, US

(73) Assignee: CONOPCO, INC., d/b/a UNILEVER

(21) Appl. No.: 11/244,622

(22) Filed: Oct. 6, 2005

(51) Int. Cl. G06K 19/06; G06K 19/00

(52) U.S. Cl. 235/494; 235/487

(57) ABSTRACT

An article and a process are provided for assembling a package and correct label form the article. The article includes a water insoluble web, a transparent icon arranged on the web, the icon being formed by a material including a substance fluorescent within a wavelength ranging from about 385 to about 620 nm.

### BACKGROUND OF THE INVENTION

1. Field of the Invention

The invention concerns a data matrix code printed onto consumer product packaging as an aid in a manufacturing system.

2. The Related Art

Data matrix codes are information reporting icons used in many manufacturing processes. Consumer product packaging has been particularly receptive to use of these codes.

Illustrative use of data matrix codes can be found in the assembly of a package such as a plastic bottle. A label will be printed with a data matrix code through which assembly information is embedded. A camera and decoding system will insure that a product filled plastic bottle will receive a proper front label. The decoding system will also insure that a proper matching back panel label will be applied to the bottle. Correct orientation of the applied label is also checked as a result of the decoded information.

Unfortunately there are problems with data matrix codes. Valuable space on often cramped labels must be reserved for the code icons. They can be aesthetically displeasing or at least annoying to the overall label design.

Equipment to excite, detect, decode and thereupon implement action on product filling lines is relatively immobile. Filling lines usually cater to more than one type of product variant (i.e. different shop-keeping-units known as SKU). Naturally these variants will have at least slightly different label graphics. Sometimes the graphics between one product and another are substantially different. Unfortunately the code reading equipment is hardened and therefore can only focus on the same location of any label. This immobility constrains all SKU labels to reserve the same space for placement of the code icon no matter how aesthetically inconvenient. Indeed, it would even be useful to visibly eliminate the code icon; it conveys no information to the consuming public nor has any trademark or aesthetic appeal.

Invisible barcode symbols have been reported in U.S. Pat. No. 6,857,573 B2 (Urano et al.). Therein is described an invisible symbol formed by a compound which includes a cyano group. The compound emits an infrared absorption wavelength carrying information about the article to which it is attached.

U.S. Pat. No. 5,959,296 (Cyr et al.) describes an apparatus for detecting an invisible, near infrared fluorescing mark. The reported apparatus and process enables the detection of fluorescent light emanating from particular infrared fluorescing compounds against backgrounds of varying optical density. Absorption wavelengths of the compound range from 680 to 780 nm representing the near infrared range of fluorescence.

### SUMMARY OF THE INVENTION

An article is provided which includes:
a water insoluble web;
a transparent icon arranged on the web, the icon being formed by a material including a substance fluorescent within a wavelength ranging from about 385 to about 620 nm.

Also provided is a process for assembling a package with correct label, the process including:
filling a consumer product into a package;
applying a label to a wall of the package, the label including a transparent icon, the icon being formed by a material including a substance fluorescent within a wavelength ranging from about 385 to about 620 nm; and
exciting the substance to emit a fluorescent signal and detecting the signal; and
decoding the signal to obtain information to correlate the label and package.

The icon of the present invention is a matrix which includes from about 10 to about 1,000 identically shaped geometric objects. More preferably the objects will range in number from about 10 to about 200. Square objects are particularly useful, especially when the icon is intended to be a matrix code.

Fluorescent wavelengths according to the present invention will range from about 385 to about 620 nm, preferably from about 430 to about 600 nm, more preferably from about 480 to about 580 nm, optimally about 532 nm.

Icons with data information according to the present invention preferably will have a regular outer border. Oval, circular, square and rectangular shaped borders may all be suitable. However, the most preferred is the square geometry.

Advantageously, total surface area of the icon may range from about 0.01 to about 1 cm², particularly from about 0.1 to about 0.5 cm², and optimally about 0.4 cm² (equivalent to a square of 0.25 inches on each side).

Plastic or cellulosic containers may be utilized for storage and sale of the consumer products according to the present invention. Paper cartons and plastic bottles are particularly appropriate packages. Where the container is a plastic bottle, the present specification will identify outer walls through the term web. Useful plastics are those at least partially formed of polypropylyene, polyethylene, polystyrene, polyethyleneterephthalate and polybutyleneterephthalate.

Icons of the present invention may be directly embossed, molded or printed onto the container web. In a most preferred embodiment, the icon is printed onto a plastic or cellulosic label. Subsequent or prior to filling a consumer product into the package, the label of the aforementioned embodiment is then adhesively applied to a web of the package.

Since the icon is transparent, the icon can be placed over any printed area of the label without detracting from readability of the underlying graphics. An icon for a data matrix code can be placed alongside a UPC (Universal Product Code) symbol or even overlay that symbol. By the term “transparent” is meant the usual dictionary meaning wherein writing covered by the icon can visibly be seen despite the overlay of that icon.

Material constituting a printed icon is preferably deposited as an ink. Particularly advantageous are inks formulated with ultraviolet light sensitive photopolymerizable resins. The resins themselves on polymer backbones may include the fluorescent substance. In a preferred embodiment, the substance is a fluorescent organic dye separate from but suspended within an ultraviolet light sensitive polymerizable resin.

Inks to imprint the icons of the present invention may be applied through a variety of procedures. Printing may be gravure, flexographic, silk-screened, inkjet, thermal image transfer, electrorepography, lithographic and letter press techniques. Most preferred is the flexographic procedure.

Materials which form the icon of the present invention advantageously are inks applied by the aforementioned techniques. Advantageously the inks are ultraviolet light curable transparent conductive compositions. In a preferred embodiment, the transparent conductive composition includes a mixture of one or more aliphatic acrylated oligomers. The aliphatic acrylated oligomer mixture is present in an amount of about 10% to 40% of the total weight of the transparent conductive composition. The aliphatic acrylated oligomer preferably comprises one or more urethane oligomers. Suitable aliphatic acrylated oligomers include Radcure Ebecryl 244 (aliphatic urethane diacrylate diluted 10% with 1,6-hexanediol diacrylate), Ebecryl 264 (aliphatic urethane triacrylate diluted 15% with 1,6-hexanediol diacrylate), Ebecryl 284 (aliphatic urethane diacrylate diluted 12% by weight with 1,6-hexandeiol diacrylate) urethanes, commercially available from Radcure UCB Corp. of Smyrna, Ga.; Sartomer CN-961 E75 (aliphatic urethane diacrylate blended with 25% ethoxylated trimethylol propane triacylate), CN-961 H81 (aliphatic urethane diacrylate blended with 19% 2(2-ethoxyethoxy)ethyl acrylate), CN-963A80 (aliphatic urethane diacrylate blended with 20% tripropylene glycol diacrylate), CN-964 (aliphatic urethane diacrylate), CN-966A80 (aliphatic urethane diacrylate blended with 20% tripropylene glycol diacrylate), CN-982A75 (aliphatic urethane diacrylate blended with 25% tripropylene glycol diacrylate) and CN-983 (aliphatic urethane diacrylate), commercially available from Sartomer Corp. of Exton, Pa.; TAB FAIRAD 8010, 8179, 8205, 8210, 8216, 8264, M-E-15, UVU-316, commercially available from TAB Chemicals of Chicago, Ill.; and Echo Resin ALU-303, commercially available from Echo Resins of Versaille, Mo.; and Genomer 4652, commercially available from Rahn Radiation Curing of Aurora, Ill. The preferred aliphatic acrylated oligomers include Ebecryl 264 and Ebecryl 284.

The transparent conductive composition may also include a photoinitiator in an amount of about 2% to 10% of the total weight of the transparent conductive composition. Suitable photoinitiators include Irgacure 184 (1-hydroxycyclohexyl phenyl ketone), Irgacure 907 (2-methyl-1-[4-morpholinophenyl)-1-butanone), Irgacure 500 (the combination of 50% 1-hydroxy cyclohexyl phenyl ketone and 50% benzophenone), Irgacure 651 (2,2-dimethoxy-1,2-diphenylethan-1-one), Irgacure 1700 (the combination of 25% bis(2,6-dimethoxybenzoyl-2,4-,4-trimethyl pentyl) phosphine oxide, and 75% 2-hydroxy-2-methyl-1-phenyl-propan-1-one), Darocur 1173 (2-hydroxy-2-methyl-1-phenyl-1-propane) and Darocur 4265 (the combination of 50% 2,4,6-trimethylbenzoyldiphenyl-phosphine oxide and 50% 2-hydroxy 2-methyl-1-phenyl-propan-1-one), available commercially from Ciba Corp., Tarrytown, N.Y.; Cyracure UVI-6974 (mixed triaryl sulfonium hexafluoroantimonate salts) and Cyracure UVI-6990 (mixed triaryl sulfonium hexafluorophosphate salts) available commercially from the Dow Chemical Company and

Genocure CQ, Genocure BOK, and Genocure m.F., commercially available from Rahn Radiation Curing. Combinations of these materials may also be employed herein.

Solvents generally may also constitute inks of the present invention. Typical solvents include low molecular weight alcohols, hydrocarbons, ketones and water. Particularly useful solvents include methanol, isopropanol, toluene, mineral spirits, methylethyl ketone, water and combinations thereof. Amounts of the solvents may range from about 5 to about 50%, preferably from about 10 to about 25% by weight of the ink material.

Ink materials of the present invention will include a fluorescent substance with the aforedescribed wavelengths, particularly those ranging from about 385 to about 620 nm. Illustrative fluorescent substances include Basic Yellow 40, Solvent Yellow 135, Solvent Yellow 160:1, Solvent Yellow 172, Solvent Yellow 44, Acid Yellow 250, Solvent Red 196, Solvent Yellow 185, Solvent Yellow 85, Solvent Yellow 43, Disperse Yellow 232 and Solvent Red 197. Amounts of the fluorescent substances may range from about 0.1 to about 20%, preferably from about 0.5 to about 10% by weight of the ink. Often the fluorescent substance is dosed to the ink composition as a powdered material. The powder is a mixture of the fluorescent substance in a resin which combination has been hardened and pulverized to a fine powder.

Typical consumer products in the most preferred aspect of this invention are consumable liquids of the home or personal care formulation variety. More specifically, the formulations can be shower gels, skin lotions, shampoos, laundry detergent and liquid fabric softeners. Consumable food products may also utilize the icon system and include but are not limited to salad dressings, mayonnaise, beverages, ice cream, margarines and spreads, peanut butter, oils, tomato products and candy bars.

### BRIEF DESCRIPTION OF THE DRAWING

Further features, aspects and advantages of the present invention will become more apparent through consideration of the following drawing in which:

FIG. 1 is a label intended for placement on a front surface web of a container for dispensing lotion;

FIG. 2 is a rear panel view of a dispenser with nozzle illustrating a data matrix code (in visible form).

### DETAILED DESCRIPTION OF THE INVENTION

Now there is provided a solution to many of the aforementioned problems. Particularly, there is provided an icon with data scannable by an optical reader system which icon can be placed on a package label irrespective of any graphics which happen to occupy the label area. Labels for different SKU varieties can be processed through a stationary scanning system without concern for placement of the icon over an already printed section of the label.

It has been discovered that solution of the problems is achieved by use of a transparent icon. This icon bearing data is printed with a material that includes a substance fluorescent within a wavelength ranging from about 385 to about 620 nm. In the preferred embodiment, the fluorescent substance is an organic dye added as a solid suspension to an ultraviolet light sensitive polymerizable resin.

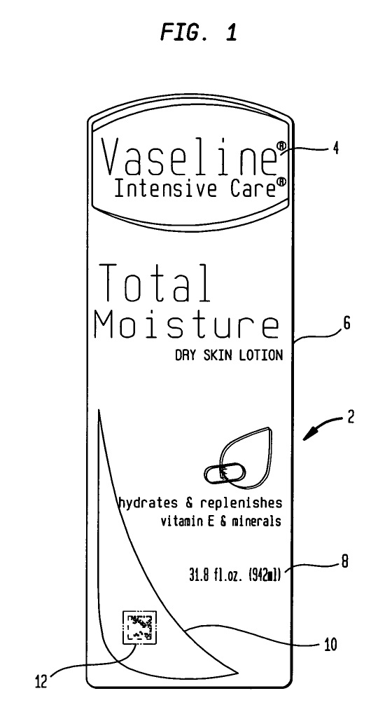

FIG. 1 represents a label intended for adhesive application to a front web of a plastic skin lotion dispensing bottle. Label 2 includes graphics such as a trademark 4, product description 6, fill weight 8 and a fanciful design 10. Placed in a field of the design 10 is an information icon 12 formatted as a data matrix code. Icon 12 is transparent allowing the design 10 to be viewed without interference. For purposes of the drawing in FIG. 1, icon 12 is drawn in dotted line fashion merely for visualization.

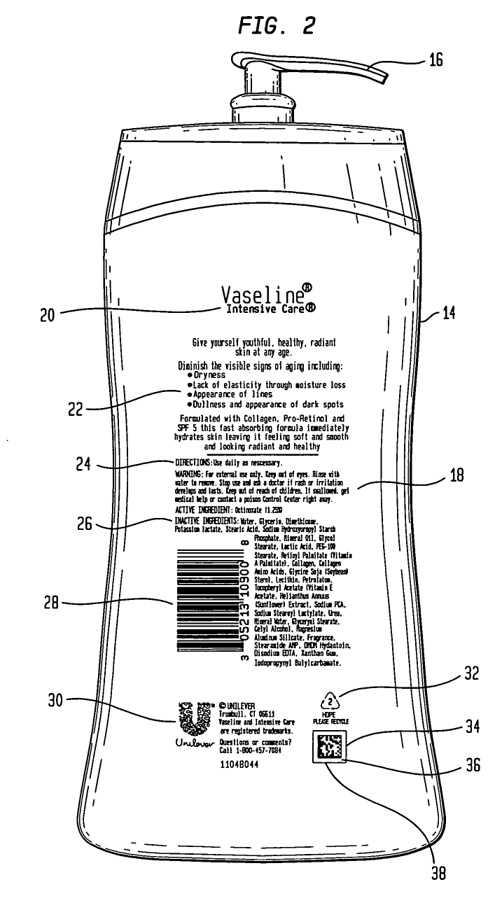

FIG. 2 illustrates a plastic bottle 14 having a product dispensing nozzle 16. Along a length of a rear face web of the bottle is a label 18 adhesively applied thereto. Graphics on the label include trademark 20, advertising 22, use directions 24, ingredient listing 26, a UPC symbol 28, manufacturer identification information 30, recycle symbol 32 and a data matrix icon 34.

Icon 34 is shown in solid lines merely for purposes of visualization for this patent application. Otherwise the icon would be transparent allowing observers to read any graphics or see the colored web underneath. The icon is in the present embodiment shown as a square having a non-readable frame 36 surrounding a code field 38. All readable information is present as a series of boxes within the matrix field 38. Information is conveyed by means of a particular arrangement of the boxes.

Except in the operating and comparative examples, or where otherwise explicitly indicated, all numbers in this description indicating amounts of material ought to be understood as modified by the word “about”.

The term “comprising” is meant not to be limiting to any subsequently stated elements but rather to encompass non-specified elements of major or minor functional importance. In other words the listed steps, elements or options need not be exhaustive. Whenever the words “including” or “having” are used, these terms are meant to be equivalent to “comprising” as defined above.

### EXAMPLE 1

Experiments were conducted to evaluate the effect of different fluorescent wavelengths on readability of the transparent icon. Ink varnishes were utilized to apply a data matrix code onto labels for attachment to a plastic bottle web. The ink varnishes were formulated with a fluorescent substance. A Hawkeye camera was used to read the data matrix codes. The data matrix code was in the form of a square 0.635 by 0.635 cm (total surface area of 0.40 cm²). Seven sample container types with walls of different colors were included in the evaluation.

Table I below summarizes results of the experiments.

TABLE I

| Ink Varnish | | |
|---|---|---|
| (Fluorescent Wavelengths) | Color of Bottle Web | Readability Rating |
| Blue (460 nm) | Blue-Pearl | 9 |
| Blue (460 nm) | Green-Pearl | 6 |
| Blue (460 nm) | Pink-Pearl | 6 |
| Blue (460 nm) | Violet-Pearl | 9 |
| Blue (460 nm) | White | 8 |
| Blue (460 nm) | White-Pearl | 10 |
| Blue (460 nm) | Yellow | 6 |
| Yellow (532 nm) | Blue-Pearl | 10 |
| Yellow (532 nm) | Green-Pearl | 10 |
| Yellow (532 nm) | Pink-Pearl | 10 |
| Yellow (532 nm) | Violet-Pearl | 10 |
| Yellow (532 nm) | White | 10 |
| Yellow (532 nm) | White-Pearl | 10 |
| Yellow (532 nm) | Yellow | 10 |

The tests demonstrated that the yellow 532 nm fluorescent data matrix codes yielded the highest clarity and readability. The blue 460 nm labels were also useful for the present invention although they appeared overall fuzzier and thereby less reliable to read.

### EXAMPLE 2

A variety of inks suitable for the present invention can be formulated with components as described below.

Ink composition A: 70 parts Ebecryl 284, 3 parts of Irgacure 1700, 3 parts of trimethylolpropane triacrylate, 3 parts of 2-ethylhexyl acrylate, 1 part of Solvent Yellow 160:1 and 30 parts hexadecane are mixed together to obtain the ink composition.

Ink composition B: 82 parts of polyethylene glycol 400 diacrylate, 3 parts of Irgacure 184, 1 part of acrylated silicone (Ebercyl 350), 2 parts of Solvent Red 196 and 14 parts of water are mixed together to obtain the ink composition.

Ink composition C: 30 parts of trimethoylpropane triacrylate, 25 parts of tripropylene glycol diacrylate, 24 parts of epoxy acrylate, 7 parts of benzophenone, 3 parts of Dispersed Yellow 232, 1 part of Irgacure 651, 3 parts of triethanolamine and 2 parts of a silicone are mixed together to obtain the ink composition.

Ink composition D: 86 parts Ebercryl 264, 30 parts Elotex 2030 water-soluble polymer, 4 parts of Irgacure 500, 2 parts of Solvent Yellow 44, 2 parts of trimethylolpropane triacrylate, 1 part of hexadecane and 30 parts of aqueous sodium lauryl sulphate solution (20 mM) are mixed together to obtain the ink composition.

What is claimed is:

1. An article comprising:
a water insoluble web;
a transparent icon arranged on the web, the icon being formed by a material comprising a substance fluorescent within a wavelength ranging from about 385 to about 620 nm.

2. The article according to claim 1 wherein the icon is a matrix comprising from about 10 to about 1,000 identically shaped geometric objects.

3. The article according to claim 2 wherein the matrix comprises from about 10 to about 200 identically shaped geometric objects.

4. The article according to claim 2 wherein the objects are square.

5. The article according to claim 1 wherein the icon is a data matrix code.

6. The article according to claim 1 wherein the wavelength ranges from about 430 to about 580 nm.

7. The article according to claim 1 wherein the wavelength ranges from about 480 to about 580 nm.

8. The article according to claim 1 wherein the wavelength is about 532 nm.

9. The article according to claim 1 wherein the icon has a surface area ranging from about 0.01 to about 1 cm².

10. The article according to claim 1 wherein the icon has a surface area ranging from about 0.1 to about 0.5 cm².

11. The article according to claim 1 further comprising a plastic label adhesively attached to the web.

12. The article according to claim 1 wherein the material further comprises an ultraviolet light photopolymerized resin.

13. The article according to claim 1 wherein the substance is a fluorescent organic dye suspended in an ultraviolet light sensitive polymerizable resin.

14. The article according to claim 1 wherein the web is a molded or plastic bottle.

15. The article according to claim 1 wherein the article is a plastic bottle, the plastic being filled with a consumable liquid home or personal care formulation.

16. The article according to claim 1 wherein the icon is flexographically printed onto the web.

17. The article according to claim 1 further comprising a Universal Product Code symbol.

18. A process for assemblying a packager with a correct label comprising:
filling a consumer product into a package;
applying a label to a wall of the package, the label comprising a transparent icon, the icon being formed by a material including a substance fluorescent within a wavelength ranging from about 385 to about 620 nm; and
exciting the substance to emit a fluorescent signal and detecting the signal; and
decoding the signal to obtain the information to correlate the label and package.
